(19) United States
(12) Patent Application Publication
(10) Pub. No.: US 2025/0370278 A1
(43) Pub. Date: Dec. 4, 2025

(54) LENS FOR SELECTIVE MIRRORING GLASSES AND METHOD FOR REALIZING A SELECTIVE MIRRORING LENS

(71) Applicant: LUXOTTICA S.R.L., Agordo (BL) (IT)

(72) Inventors: Elena CAPETTI, Caravaggio (BG) (IT); Flavio RABEZZANA, Agordo (BL) (IT)

(21) Appl. No.: 18/870,932

(22) PCT Filed: Jul. 25, 2023
(86) PCT No.: PCT/IB2023/057535

§ 371 Date: Dec. 2, 2024

(30) Foreign Application Priority Data
Jul. 29, 2022 (IT) 102022000016152

(51) Int. Cl. G02C 7/10; B29D 11/00

(52) U.S. Cl. CPC G02C 7/107; B29D 11/00923

(57) ABSTRACT

The present invention relates to a lens (10) for selective mirroring glasses, said lens having a convex side (20) and a concave side (30) wherein said selective mirroring is realized both on the convex side (20) and on the concave side (30) of the lens (10), said realization of the selective mirroring both on the convex side (20) and on the concave side (30) of the lens (10) realizing an image (40) with three-dimensional or perspective effect on the lens (10) itself. The invention also relates to a method for obtaining a lens (10) for glasses with selective mirroring, said method envisaging the steps of: 1. preparation of the lens 10, 2. application of the pad printing on the convex side 20 of the lens, 3. drying of the paint applied in step 2, 4. application of the pad printing on the concave side 30 of the lens, 5. drying of the paint applied in step 4, 6. carrying out a physical vapour deposition or PVD treatment on the concave side 30 of the lens 10, 7. carrying out a physical vapour deposition or PVD treatment on the convex side 20 of the lens 10, 8. obtaining the final lens 10 subjected to the previous steps for the removal of the pad printing paint, said steps 2 and 4 being also able to be carried out in reverse, that is to say firstly step 4 and then, after step 3, step 2.

The present invention refers to a lens for selective mirroring glasses.

More specifically, the invention refers to a lens for glasses envisaging selective mirroring on both sides, said selective mirroring being capable of providing a three-dimensional or perspective effect on the lens itself.

Selective mirroring means a mirroring limited to a precise area or zone of the surface of the lens.

The invention also refers to a method for realizing selective mirroring lens.

Hereinafter, lens will mean any type of lens, both vision corrective or not, and of any shape, included a mask shape, and made of glass and/or plastic.

Lenses for selective mirroring glasses are already available on the market. However, known lenses envisage mirroring only on one side of the lens, mainly the external side, thereby the image obtained by the selective mirroring on the lens is two-dimensional.

The need to have lenses for glasses with increasing attraction, and thus also with mirroring with three-dimensional or perspective image effect, is available on the market.

Currently, lenses having this type of effect do not exist, since a technology capable of obtaining this type of result has not been developed yet.

In view of this need, the Applicant has studied and carried out a product being able to solve the market need, obtaining a lens with selective mirroring on both sides, and with a three-dimensional or perspective effect of the figure emerging from the selective mirroring.

The Applicant has also found and carried out a method capable of realizing a lens with selective mirroring and with three-dimensional or perspective effect.

These and other results are obtained according to the invention by a lens with selective mirroring according to the independent claim 1.

Other features of the lens with selective mirroring are specified in the dependent claims 2-7.

In the independent claim 8 a method for realizing said lens with selective mirroring is described.

The present invention will be now described for illustrative, but not limiting, purposes according to preferred embodiments thereof, with particular reference to the figures of the attached drawings, wherein:

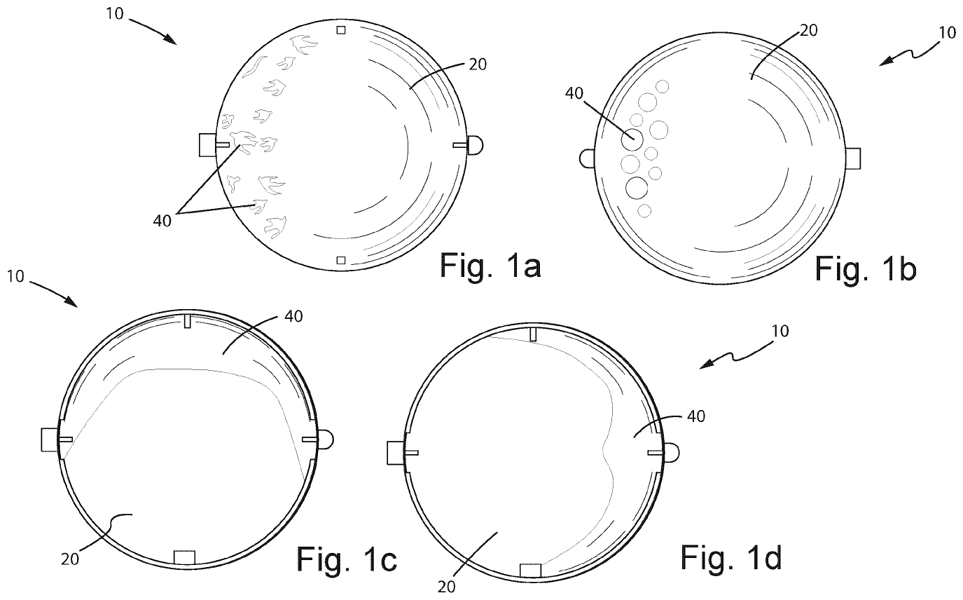

FIGS. 1a-1d show some lenses with selective mirroring on both sides according to the invention observed in transmission;

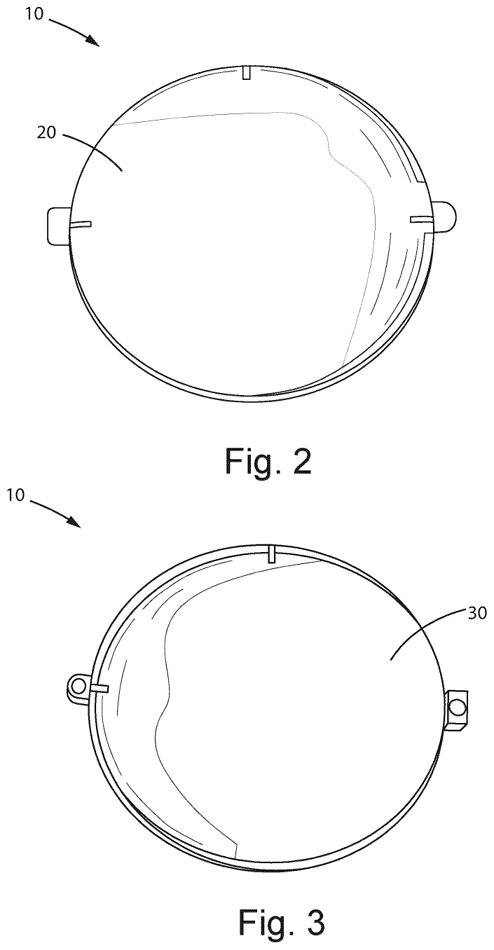

FIG. 2 shows a variant of a lens with selective mirroring on the convex side according to the invention observed in reflection; and

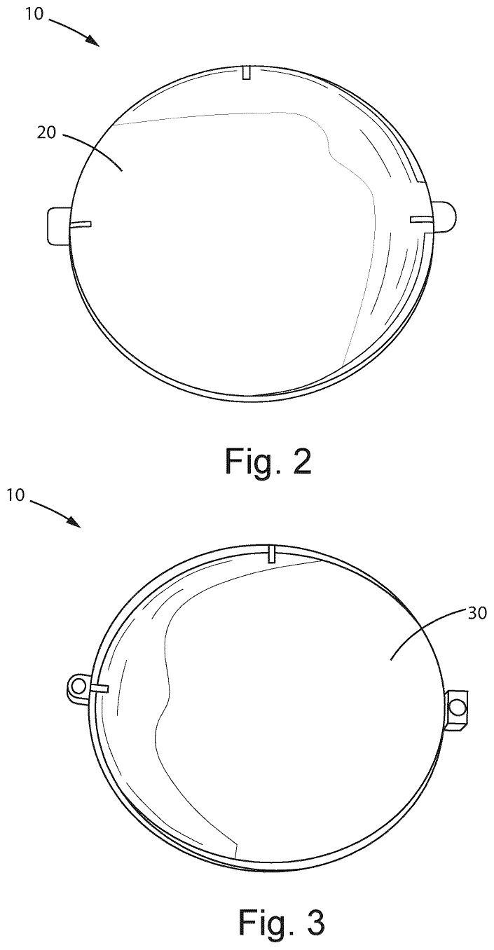

FIG. 3 shows a variant of a lens with selective mirroring on the concave side observed in reflection.

Turning now to observe the figures in the attached drawings, it is observed, in particular from FIG. 1, that each lens for glasses, generally referred to as numerical reference 10, envisages a convex side 20 and a concave side 30.

After the selective mirroring treatment according to the present invention, a three-dimensional or perspective image, generally referred to as numerical reference 40 is observed on each lens 10 (in particular, see FIG. 1). The perspective image is appreciable only if the lens is observed in transmission.

Hereinafter, still referring to the drawings of the attached figures, a method for realizing a lens 10 with selective mirroring on both sides is described.

As will be apparent below, the solution according to the invention envisages the application of the selective mirroring on both faces of the lens 10 for glasses.

As already said, the lens 10 can have any shape, be made of glass and/or plastic material, and also be of the vision-corrective type, as long as the perspective effect is outside the optical centre.

In the preferred embodiment, the method according to the invention envisages the following steps:
1. preparation of the lens 10,
2. application of the pad printing on the convex side 20 of the lens,
3. drying of the paint applied in step 2,
4. application of the pad printing on the concave side 30 of the lens,
5. drying of the paint applied in step 4,
6. carrying out a physical vapour deposition or PVD treatment on the concave side 30 of the lens 10,
7. carrying out a physical vapour deposition or PVD treatment on the convex side 20 of the lens 10,
8. obtaining the final lens 10 subjected to the previous steps for the removal of the pad printing paint.

In particular, it should be observed that the two concave side 30 (step 6) and convex side 20 (step 7) treatments are different from each other, and thus they cannot be carried out in reverse, since in this manner, according to the invention, the above-mentioned desired three-dimensional or perspective effect on the lens 10 is obtained.

In more detail, the PVD treatment on the concave side 30 consists in the application of a series of layers or multilayers composed of:
an absorbent layer (constituted by also precious metals such as Gold, White Gold, Rose Gold, Silver, Titanium or Chrome).
an anti-reflective multilayer (constituted by way of example by titanium oxides, zirconium oxide and silicon oxides).

The reflectance of the internal treatment does not exceed 5% (so as not to induce disturbing reflections towards the eyes of the wearer of the lens 10).

Referring to the treatment according to step 7 on the convex side 20, it concerns the application of a dichroic mirror, of various colours (known in the art as mirroring).

Indeed, the order of carrying out the steps (1. 2.) and (3. 4.) can be reversed, without affecting the final product. Any removable solvent-based pad printing ink can be applied for pad printing.

A number of other treatments can be also applied to the lens 10, by way of example but not limited to, anti-reflection, mirroring, anti-fog, or anti-mist, hydrophobic and/or oleophobic or anti-stain, anti-scratch, anti-static treatments, and other treatments known in the state of the art. Said treatments can be applied on the convex side 20 and/or on the concave side 30 of the lens 1.

The present invention has been described, for illustrative but not limiting purposes, according to preferred embodiments thereof, being intended that a person skilled in the art can make changes thereto, without departing from the scope of protection as defined in the attached claims.

1. Lens (10) for selective mirroring glasses, said lens having a convex side (20) and a concave side (30) wherein said selective mirroring is realized both on the convex side (20) and on the concave side (30) of the lens (10), said realization of the selective mirroring both on the convex side (20) and on the concave side (30) of the lens (10) realizing an image (40) with three-dimensional or perspective effect on the lens (10) itself.

2. Lens (10) according to claim 1, wherein first the concave side (30) and then the convex side (20) of the lens are treated.

3. Lens (10) according to claim 2, wherein a physical vapour deposition or PVD treatment is carried out on at least one of said concave (30) or convex side (20).

4. Lens (10) according to claim 2, wherein a physical vapour deposition or PVD treatment is carried out on both said concave side (30) or convex side (20).

5. Lens (10) according to claim 3, wherein the PVD treatment on the concave side (30) consists in the application of a multilayer composed of:
an absorbent layer (constituted by also precious metals), and
an anti-reflective multilayer,
the reflectance of the treatment on the concave side (30) not exceeding 5%, so as not to induce disturbing reflections towards the eyes of the wearer of the lens (10).

6. Lens (10) according to claim 4, wherein said absorbent layer is constituted by metals such as Gold, White Gold, Rose Gold, Silver, Titanium or Chrome.

7. Lens (10) according to claim 4, wherein said anti-reflective multilayer being constituted by titanium oxides, zirconium oxide and silicon oxides.

8. Lens (10) according to claim 6, wherein said PVD treatment envisages the application of a dichroic mirror, of various colours, or mirroring.

9. Method for obtaining a lens (10) for glasses with selective mirroring, said method envisaging the steps of:
1. preparation of the lens 10,
2. application of the pad printing on the convex side 20 of the lens,
3. drying of the paint applied in step 2,
4. application of the pad printing on the concave side 30 of the lens,
5. drying of the paint applied in step 4,
6. carrying out a physical vapour deposition or PVD treatment on the concave side 30 of the lens 10,
7. carrying out a physical vapour deposition or PVD treatment on the convex side 20 of the lens 10,
8. obtaining the final lens 10 subjected to the previous steps for the removal of the pad printing paint,
said steps 2 and 4 being also able to be carried out in reverse, that is to say firstly step 4 and then, after step 3, step 2.

10. Method according to claim 8, wherein the PVD treatment on the concave side (30) consists in the application of a multilayer composed of:
an absorbent layer (constituted by metals),
an anti-reflective multilayer.
the reflectance of the concave side (30) of the lens not exceeding 5%.

11. Method according to claim 9, wherein said absorbent layer is constituted by metals such as Gold, White Gold, Rose Gold, Silver, Titanium or Chrome.

12. Method according to claim 9, wherein said anti-reflective multilayer is constituted by titanium oxides, zirconium oxide and silicon oxides.

13. Method according to claim 8, wherein the treatment on the convex side (20), envisages the application of a dichroic mirror, of various colours, or mirroring.

14. Method according to claim 8, wherein any removable solvent-based pad printing ink can be applied for pad printing.
